(19) United States
(12) Patent Application Publication
(10) Pub. No.: US 2025/0380781 A1
(43) Pub. Date: Dec. 18, 2025

(54) HAIR STYLING APPLIANCE

(71) Applicant: Dyson Technology Limited, Malmesbury Wiltshire (GB)

(72) Inventor: Eric SERRA, Chippenham (GB)

(21) Appl. No.: 18/877,286

(22) PCT Filed: Jun. 8, 2023
(86) PCT No.: PCT/IB2023/055919

§ 371 Date: Dec. 20, 2024

(30) Foreign Application Priority Data
Jun. 21, 2022 (GB) 2209090.6

(51) Int. Cl. A45D 2/00

(52) U.S. Cl. CPC A45D 2/002

(57) ABSTRACT

Disclosed herein is a hair styling appliance that includes electrodes and a control system that, during operation, energises the electrodes to heat hair dielectrically. A shielding bounds the electrodes to block an electromagnetic field that is generated by the electrodes when energised. Further, a sensor assembly is located outside of the shielding, and the sensor assembly is used to sense a property of hair for the hair styling appliance.

### TECHNICAL FIELD

The present invention relates to a hair styling appliance.

### BACKGROUND

A hair styling appliance may comprise heating plates that are heated to temperatures of around 200° C. Hair is then clamped between the heating plates, and the high temperatures break hydrogen bonds within the hair, allowing the hair to be reshaped and styled.

### SUMMARY OF THE INVENTION

According to the invention, there is disclosed a hair styling appliance comprising electrodes, a control system operable to energise the electrodes to heat hair dielectrically, shielding bounding the electrodes to block an electromagnetic field generated by the electrodes when energised, and a sensor assembly located outside the shielding, the sensor assembly to sense a property of hair.

With the hair styling appliance of the present invention, hair is heated dielectrically. Consequently, in contrast to a conventional styling appliance having heating plates, the hair may be heated without first having to heat a surface of the appliance. The appliance is therefore potentially safer since it is not necessary to heat the appliance to temperatures of around 200° C. Although the temperature of the appliance may increase during use, this arises from the transfer of heat from the hair to the appliance, rather than the other way around. Additionally, in comparison to a conventional styling appliance having heating plates, the appliance of the present invention is potentially more efficient. With a conventional styling appliance, the electrical power drawn by the heating plates can be significant even when there is no hair between the plates. With the appliance of the present invention, on the other hand, relatively little power is likely to be drawn by the electrodes in the absence of hair. This is because the power drawn by the electrodes depends on the impedance of the electrodes, which in turn depends on the dielectric constant of the material between the electrodes. The dielectric constant of air is around 1 and therefore, in the absence of hair, the power drawn by the electrodes is likely to be relatively low.

Excessive heating and/or drying by a hair styling appliance can damage hair. In conventional styling appliances, excessive heating can be avoided by sensing the temperature of the heating plate, which is used to transfer heat to the hair, and regulating the power to the heating plate in response. However, with the hair styling appliance of the present invention, there is no heating plate or other thermal mass for heating the hair. So conventional means for regulating temperature are unlikely to be suitable. Additionally, the electromagnetic field that is generated by the electrodes when energised can interfere with sensing equipment. Accordingly, the hair styling appliance of the present invention comprises shielding that blocks the electromagnetic field generated by the electrodes. A sensor assembly located outside of the shielding then senses a property of the hair. The provision of the shielding and the location of the sensor assembly outside the shielding allows a property of the hair to be reliably sensed without interference from the energised electrodes.

The sensor assembly may be configured to sense a value and/or characteristic that is indicative of a property of the hair. This may render a wider range of sensors suitable for determining the property of the hair without directly sensing the property of the hair.

The sensed property may be temperature of the hair. By sensing hair temperature, the sensor assembly may help to identify when the hair is at risk of damage from excessively high temperatures and/or identify when there is insufficient power being supplied to the electrodes to heat the hair sufficiently to style the hair.

The sensed property may be humidity, or moisture content, of the hair. By sensing hair humidity, the sensor assembly may help to identify when the hair is at risk of damage from the hair becoming too dry and/or to identify when there is insufficient power being supplied to the electrodes to dry the hair sufficiently to style the hair.

The sensed property may be speed of movement of the hair, for example relative to the electrodes. By sensing the speed of movement of the hair, the sensor assembly may help to identify when the hair is at risk of damage from being heated by the electrodes for a longer than advisable period of time and/or to identify when the hair is moving too fast to be sufficiently heated by the electrodes.

The sensor assembly may be configured to sense more than one property of hair, for example temperature, humidity and/or speed of movement. The control system may be operable to control energisation of the electrodes in response to the sensed properties of the hair. This may help to improve the styling performance of the hair styling appliance.

The sensor assembly may comprise a sensor to contact hair to sense the property of the hair. This may provide rapid sensing of the sensed property and allow the use of low-cost sensors. For example, the sensor assembly may comprise a thermistor and a low pass filter. A thermistor may provide good resolution of hair temperature, allowing finer control of the input power drawn by the electrodes based on hair temperature. A thermistor may also provide a fast response to temperature changes, to quickly measure hair temperature. A low pass filter may help to filter out interference signals, to provide a more reliable reading of hair temperature.

The sensor may contact hair outside the shielding. This may provide a simpler arrangement compared to the sensor contacting hair inside the shielding.

The sensor assembly may comprise a sensor to sense the property of hair without contacting the hair. This may provide a more reliable measure of the property of hair located between and heated by the electrodes. For example, the sensor assembly may be located outside of the shielding but may be directed towards a region inside the shielding. In examples, the sensor assembly may comprise an infrared thermal sensor, which may provide a fast and accurate temperature reading.

The electrodes may be configured to heat dielectrically hair located within a hair treatment zone and the shielding may confine the electromagnetic field generated by the electrodes to the hair treatment zone. This may further improve the safety and/or efficiency of the appliance.

The sensor assembly may sense a property of hair located outside the hair treatment zone. This may allow for energising of the electrodes and sensing by the sensing assembly to occur concurrently because the electromagnetic field generated by the electrodes is prevented from interfering with the sensor assembly by the shielding. For example, a sensor in the sensor assembly may contact hair outside the hair treatment zone.

The sensor assembly may sense a property of hair exiting the hair treatment zone. A potential difficulty with sensing hair outside the hair treatment zone is that the hair may have a very different property to hair inside the hair treatment zone. For example, the temperature or humidity of hair outside the zone may be very different to that inside the hair treatment zone. As a result, excessive heating or drying of hair within the hair treatment zone could occur. However, by sensing a property of hair exiting the hair treatment zone, a more accurate indication of the property of hair inside the hair treatment zone may be achieved.

The control system may be operable to energise the electrodes by applying an alternating voltage to the electrodes. The control system may be operable to vary a property of the alternating voltage in response to the sensed property of the hair. The property of the alternating voltage may be amplitude, frequency or both, for example. By varying a property of the alternating voltage, the input power drawn by the electrodes (and thus the output power transferred to the hair) can be controlled. Additionally, by varying a property of the alternating voltage based on the sensed property, the safety and/or efficiency of the appliance may be improved.

The control system may be operable to apply a first alternating voltage to the electrodes if the sensed property meets a criterion, and to apply a second, different alternating voltage to the electrodes if the sensed property does not meet the criterion. This provides a relatively simple mechanism for controlling the input power, and thus the output power, of the styling appliance based on the sensed property.

The second alternating voltage may have a lower amplitude or a lower frequency than the first alternating voltage. As a result, heating of the hair by the electrodes may be reduced in the event that the criterion is not met. In an example, the criterion may be met in the event that the temperature of the hair is less than a temperature threshold and/or the humidity of the hair is greater than a humidity threshold. As a result, heating of the hair may be reduced so as to avoid excessive heating or drying of the hair. In examples, the second alternating voltage may be zero.

The criterion may be met in the event that the temperature of hair is less than a temperature threshold and the second alternating voltage may generate less heat in the hair than the first alternating voltage. Accordingly, heating of the hair may be reduced and/or stopped when the sensor assembly senses that the temperature of the hair is at or above the temperature threshold.

The criterion may be met in the event that the humidity of hair is greater than a humidity threshold and the second alternating voltage may generate less heat in the hair than the first alternating voltage. Accordingly, drying of the hair may be reduced and/or stopped when the sensor assembly senses that the humidity of the hair is at or below the humidity threshold.

The criterion may be met in the event that a speed of movement of hair is greater than a speed threshold and the second alternating voltage may generate less heat in the hair than the first alternating voltage. Accordingly, heating of the hair may be reduced and/or stopped when the sensor assembly senses that the speed of movement of the hair is at or below the speed threshold. The speed of movement may be relative to the electrodes and/or relative to the hair treatment zone.

The sensor assembly may comprise a plurality of sensors positioned adjacent to and distributed along an edge of the shielding. This may allow the sensor assembly to sense the property of a section of hair at various locations across the width of the section. Additionally, the property of the hair is sensed as, or very soon after, the hair exits the hair treatment zone, and therefore the sensed property is more likely to better reflect the property of hair within the hair treatment zone.

The plurality of sensors may be additionally positioned adjacent to and distributed along an opposing edge of the shielding. This may allow the sensor assembly to sense the property of a section of hair at various locations both before and after the hair passes through the hair treatment zone. By sensing the property of the hair before and after the hair treatment zone, a more accurate estimate of the property of the hair inside the hair treatment zone may be achieved. This may also allow the property of the hair to be sensed as the hair exits the hair treatment zone regardless of the direction in which the hair styling apparatus is used relative to the hair.

The plurality of sensors may be comprised in a hair-corralling strip extending parallel to the edge of the shielding. A height of the hair-corralling strip may be greater than a height of the shielding. Accordingly, the hair-corralling strip may contact the hair and grip the hair such that the hair does not contact the shielding, which may help to improve the performance and/or safety of the appliance.

The sensor assembly may comprise one or more light sensors and a light pipe. The light pipe may extend parallel to an edge of the shielding and may be configured to direct light to the one or more light sensors of the sensor assembly. This may allow the one or more light sensors to be located distally from the edge of the shielding, which may allow for a more space-efficient arrangement. In examples, the one or more light sensors may comprise one or more of an infrared sensor and an optical flow sensor. The infrared sensor may be configured to sense a temperature of hair and the optical flow sensor may be configured to sense a speed of movement of hair.

The hair styling appliance may comprise a plurality of bristles. The bristles may help to detangle hair as it is styled by the hair styling appliance, which may improve styling performance. The sensor assembly may comprise a plurality of sensors, and each sensor may be disposed on a respective bristle. This may help to provide an array of sensed values indicative of the property of the hair, which may provide a more accurate determination of an average of the property of the hair. Providing the sensors on the bristles may help to keep the sensors away from the electromagnetic fields generated by the electrodes and thus reduce interference.

The hair styling appliance may comprise a pair of arms moveable between an open position and a closed position. When in the closed position, the hair treatment zone may be located between the pair of arms and the arms may grip a section of hair and hold the section of hair in the hair treatment zone. The control system may be configured to energise the electrodes when the arms are in the closed position to heat dielectrically hair within the hair treatment zone. This may help to ensure that the electrodes are not needlessly energised when the hair styling appliance is not in a position to heat hair.

Each of the arms may comprise at least one of the electrodes, and the shielding may comprise a first shield disposed on a first arm of the pair of arms and a second shield disposed on a second arm of the pair or arms. This may permit heating of hair from both sides of the hair treatment zone, which may provide a more efficient and/or better performing appliance.

The sensor assembly may comprise a first sensor positioned on a first arm of the pair of arms and a second sensor on a second arm of the pair of arms. As a section of hair passes through the hair treatment zone, different parts of the section may be heated differently, e.g., due to differences in moisture content or hair product. By having at least one sensor on each arm, the property of different areas of the section of hair (e.g., top and bottom) may be sensed, thereby providing a better overall measure of the property of the hair.

### BRIEF DESCRIPTION OF THE DRAWINGS

Examples will now be described with reference to the accompanying drawings, in which:

FIG. 1 is a side view of a hair styling appliance in an open position;

FIG. 2 is a side view of the hair styling appliance of FIG. 1 in a closed position;

FIG. 3 is a perspective view of an end of an arm of the hair styling appliance of FIG. 1;

FIG. 4 is a cross-sectional end view of the arm of FIG. 3;

FIG. 5 is a plan view of a first alternative arrangement of a sensor assembly and electrodes suitable for use with the hair styling appliance of FIG. 1;

FIG. 6 is a plan view of a second alternative arrangement of a sensor assembly and electrodes suitable for use with the hair styling appliance of FIG. 1;

FIG. 7 is a plan view of a third alternative arrangement of a sensor assembly and electrodes suitable for use with the hair styling appliance of FIG. 1;

FIG. 8 is a perspective view of an arm of further hair styling appliance;

FIG. 9 is a top view of an end of the arm of FIG. 8;

FIG. 10 is an end view of the arm of FIG. 8;

FIG. 11 is a perspective view of a first alternative arm of the further hair styling appliance;

FIG. 12 is an end view of the arm of FIG. 11;

FIG. 13 is a perspective view of a second alternative arm;

FIG. 14 is an end view of the arm of FIG. 13;

FIG. 15 is a perspective view of a third alternative arm; and

FIG. 16 is an end view of the arm of FIG. 15.

### DETAILED DESCRIPTION

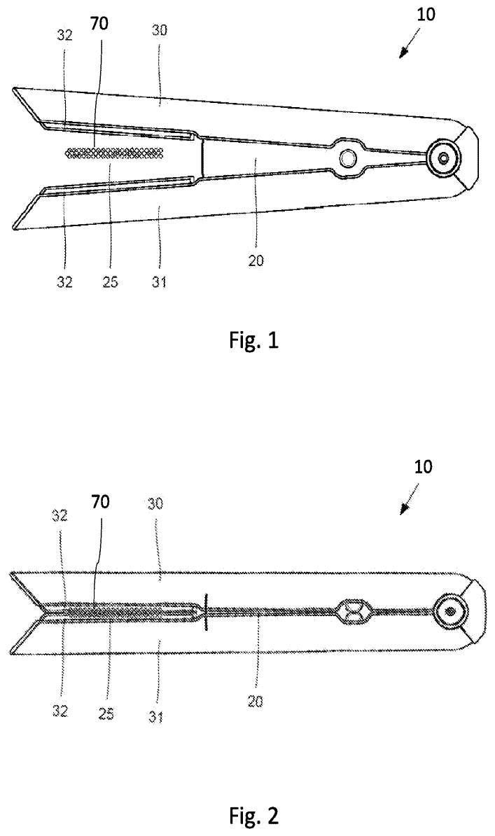

The hair styling appliance 10 of FIGS. 1 to 4 comprises a body 20, a pair of arms 30, 31, electrodes 40, a sensor assembly 50, a control system (not shown) and a battery (not shown).

The body 20 is generally elongated in shape and houses the control system and the battery.

Each of the arms 30, 31 is pivotally attached to the body 20. The arms 30,31 roughly encapsulate the body 20. The arms 30,31 are moveable between an open position, shown in FIG. 1, and a closed position, as shown in FIG. 2. The arms 30,31 are biased in the open position. During use, a section of hair 70 is received between the two arms 30, 31. The free end of each of the arms 30, 31 is chamfered or bevelled. This then helps when inserting the section of hair 70 between the two arms 30, 31. In particular, the hair 70 may be more easily gathered at the wider mouth of the arms 30, 31 and then guided into the narrow section of the arms 30, 31. When in the closed position, the arms 30,31 grip a section of hair 70. The user may then pull the appliance 10 to create tension along the length of the section of hair 70.

Each of the arms 30, 31 houses at least one of the electrodes 40 and at least one sensor 51 of the sensor assembly 50. In this example, the hair styling appliance 10 comprise a pair of electrodes 40. Each arm 30,31 therefore houses one of the pair of electrodes.

Each of the electrodes 40 comprises a rectangular metal plate. When in the closed position, the electrodes 40 of the two arms 30,31 oppose one another, and define a hair treatment zone 25 therebetween.

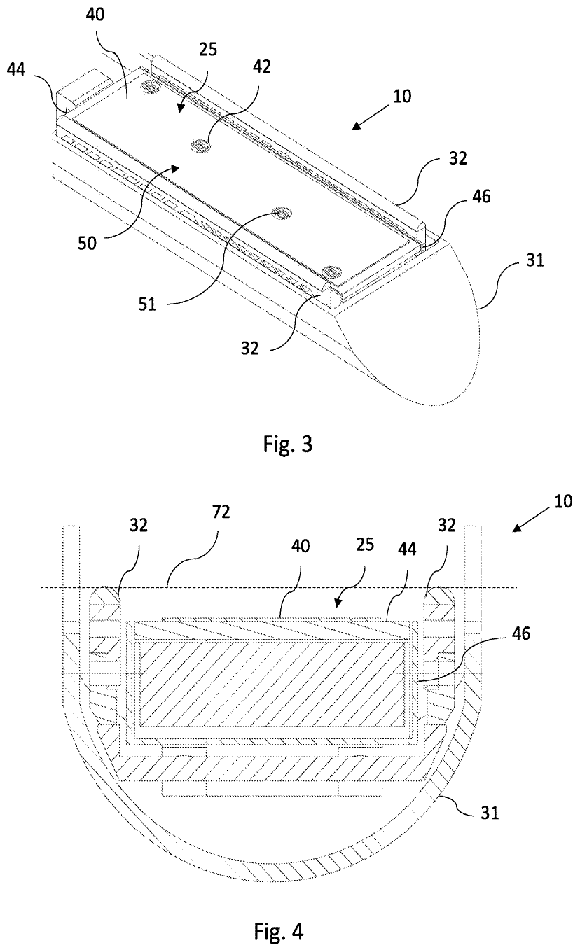

The sensor assembly 50 comprises a plurality of sensors 51 disposed in respective apertures 42 in the electrode 40 of each arm 30,31, as best shown in FIG. 3. The sensors 51 do not extend above an upper surface 43 of the electrodes 40 so that they do not snag or catch on hair passing through the hair treatment zone 25. In this example, one sensor 51 is disposed in each aperture 42, but in other examples more than one sensor 51 may be disposed in each aperture 42.

The sensor assembly 50 is configured to sense a property of the hair within in the hair treatment zone 25. In this example, the sensor assembly 50 is configured to sense the temperature of the hair and each of the sensors 51 comprises an infrared sensor. In other examples, the sensor assembly 50 may be configured to sense a different or an additional property, such as the humidity of hair in the hair treatment zone 25, or the speed with which the hair moves through the hair treatment zone 25. As discussed below in more detail, sensing one or more properties of hair may help to prevent heat-related damage to the hair and/or provide better styling results.

The sensors 51 are distributed across the respective electrode 40 such that the temperature of the section of hair 70 within in the hair treatment zone 25 is sensed at different positions. This may help to ensure that the temperature of the hair 70 is sensed even if the hair 70 does not extend across a full length of the electrode 40. By providing sensors 51 on each of the arms, the temperatures at the top and bottom of the section of hair 70 may be sensed, thereby providing a more robust measure.

The electrode 50 and the sensors 51 of each arm 30, 31 are mounted on a common substrate 44, which in this example is a PCB.

The control system is coupled to the battery, the electrodes 40 and the sensor assembly 50. The control system is operable to selectively apply an alternating voltage to the electrodes 40, when the arms 30, 31 are in the closed position, to energise the electrodes 40 to heat the section of hair 70 dielectrically. Consequently, in contrast to a conventional styling appliance having heating plates, the hair may be styled without first having to heat heating plates or other thermal mass.

In applying a voltage to the electrodes 40, an electromagnetic field is created between the electrodes 40. Since the voltage applied to the electrodes 40 is alternating, the electromagnetic field also alternates. The electromagnetic field spans the hair treatment zone 25 and acts to heat the section of hair 70 within the hair treatment zone 25. In particular, the alternating field stimulates the oscillation of polar molecules within the hair, particularly water. The oscillation of the polar molecules in turn generates heat.

Each of the arms 30, 31 comprises two gripping portions, or corralling strips, 32 on opposite sides of the electrodes 40, for gripping the hair 70. The corralling strips 32 are formed of a resiliently deformable material, such as silicone, and deform to the shape of the hair 70. As a result, the gripping pressure applied to the hair 70 by the arms 30,31 is more evenly distributed across the width of the section of hair 70. This then has the benefit that, when the arms 30, 31 are in the closed position and the appliance 10 is pulled, a more even tension is created across the section of the hair 70.

The corralling strips 32 on each arm 30, 31 have a height greater than a height of the electrodes 40, as best shown in FIG. 4. The hair 70 is therefore held taut along a hair contact line 72 extending between opposing corralling strips 32. This hair contact line 72 is spaced from the electrodes 40. As a result, an air gap is created both above and below the section hair 70. This has the benefit of reducing thermal conduction, and therefore thermal loss, between the hair 70 and the appliance 10. As a consequence of the air gap, the hair 70 is not normally in thermal contact with the sensors 51. It is for this reason that the sensors 51 in this example are infrared sensors, such that the temperature of the hair may be sensed remotely.

The corralling strips 32 of the arms 30, 31 may be formed of a thermally insulating material so as to further reduce thermal conduction between the hair 70 and the appliance 10.

The electromagnetic field generated by the electrodes 40 may cause interference with surrounding electronics, including the sensor assembly 50 and the control system within the body 20. Such interference could impede the performance of the hair styling appliance 10, for example by causing the sensor assembly 50 to output an incorrect signal.

Accordingly, each of the arms 30, 31 houses shielding 46 to block the electromagnetic field generated by the electrodes 40 when energised. The shielding 46 bounds the electrodes 40 on all sides other than the upper surfaces 23 of the electrodes 40. The shielding 46 prevents the electromagnetic field from travelling beyond the area bounded by the shielding 46 i.e., beyond the hair treatment zone 25, and thus from interfering with electronics outside the shielding 46. Nevertheless, the electromagnetic field interferes with the sensors 51 since they are located within the shielding.

The control system is therefore operable to suspend energisation of the electrodes 40 during sensing of the temperature of the hair by the sensor assembly 50. Energisation is suspended for a suspension period, during which the sensors 51 are activated to sense the temperature of the hair 70. When energisation is suspended, no voltage is applied to the electrodes 40 by the control system such that no electromagnetic field is generated during the suspension period. Accordingly, the electromagnetic fields generated by the electrodes 40 during energisation do not interfere with the sensors 51 and affect the performance of the sensor assembly 50.

In this example, the control system alternates energisation of the electrodes 40 and sensing of the temperature of the hair by the sensor assembly 50 during a hair styling operation. The sensors 51 are capable of sensing the temperature of the hair 70 over a relatively short period of time. As a result, the length of the suspension period may be kept relatively short, for example, 1 ms. The short suspension period allows the control system to suspend energisation of the electrodes 40 at a relatively high frequency without adversely impairing the heating of the hair. As a result, the temperature of the hair may be sensed at a relatively high frequency, for example, once every 0.1 s. The length and frequency of the suspension period are chosen such that heating of the hair by the electrodes is substantially unimpaired by the suspension. Sensing the temperature of the hair at a high frequency enables the control system to rapidly detect when the temperature of the hair reaches or exceeds a given value and to control energisation of the electrodes 40 accordingly.

The control system is operable to vary a property of the alternating voltage used to energise the electrodes in response to the sensed temperature of the hair. In this example, the control system varies the amplitude of the alternating voltage. In other examples the control system may additionally or alternatively vary the frequency of the alternating voltage. When the sensed temperature of the hair rises to or above a temperature threshold, the control system is operable to reduce an amplitude of the alternating voltage compared to an amplitude of the alternating voltage. As a result, a rate of heating of the hair 70 is reduced, which may help to prevent over-heating of the hair.

In some examples, the control system is operable to increase an amplitude of the alternating voltage if the sensed temperature of the hair falls below a lower temperature threshold. This may occur, for example, if part of the hair 70 is wetter than another part of the hair so that the temperature of the hair is maintained above a lower temperature threshold to provide better and/or quicker styling results.

In some examples, the control system is operable to alter the amplitude of the alternating voltage based on a rate of temperature change in the hair. For example, if the hair 70 increases in temperature faster than a permitted rate, the control system is operable to reduce the amplitude of the alternating voltage to help prevent over-heating of the hair 70.

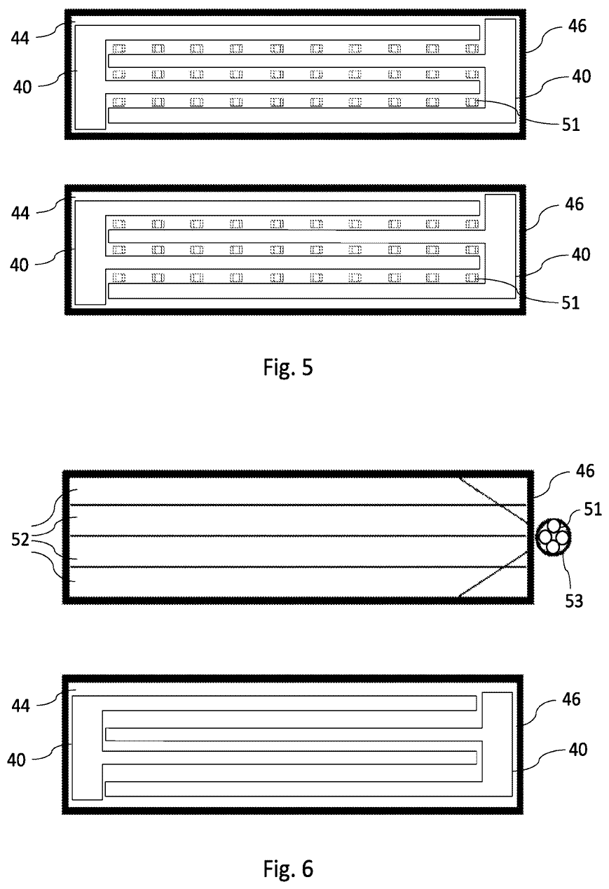

FIGS. 5 to 7 show different arrangements of electrodes 40 and sensors 51 suitable for use with the hair styling appliance 10. Each Figure shows the electrodes 40, sensors 51 and shielding 46 in one arm 30 (upper image) and in the other arm 31 (lower image).

In the example shown in FIG. 5, each arm 30, 31 comprises two electrodes 40 disposed on a PCB 44 and arranged to interleave one another. The sensors 51 are disposed on the PCB 44 in between the electrodes 40 on the respective arm 30, 31. Such an arrangement may be simpler to manufacture than the arrangement shown in FIG. 3. Such an arrangement may also allow provision of a greater number of sensors 51 within the shielding 46, albeit with a small surface area of electrodes 40 which may reduce heating performance. Although shown with three rows of sensors 51, in other examples there may be a greater or lesser number of rows and a greater or lesser number of sensors 51 in each row.

In the example shown in FIG. 6, one arm 30 comprises a plurality of light pipes 52 extending across the area bounded by the shielding 46. An array 53 of sensors 51 is positioned outside of the shielding 46 and configured to receive light from each of the light pipes 52. The array 53 comprises infrared sensors to determine a temperature of hair within the hair treatment zone 25 and optical flow sensors to determine a speed of movement of hair within the hair treatment zone 25. By providing light pipes 52, the sensors 51 can be located outside of the shielding 46, thus reducing interference from the electromagnetic fields generated by the electrodes 40. Accordingly, with this configuration it may not be necessary to suspend energisation of the electrodes 40 during sensing by the sensor assembly 50. The light pipes 52 also provide hair property information, in this example temperature and speed of movement, across substantially all of the area bounded by the shielding 46, thus providing a more accurate depiction of the property of hair in the hair treatment zone. However, providing light pipes 52 may be relatively expensive. There are no electrodes on the arm 30. The other arm 31 comprises two electrodes 40 arranged to interleave one another. There are no sensors disposed on the other arm 31. This may provide a simple means of manufacture and assembly.

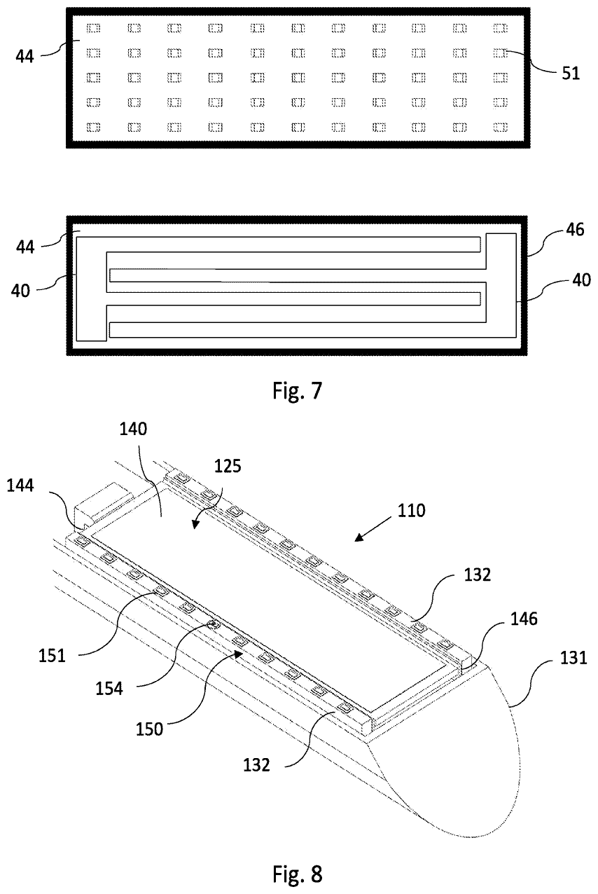

In the example shown in FIG. 7, one arm 30 comprises an array of sensors 51 disposed on a PCB 44. Such an arrangement is relatively cheap and simple to manufacture compared to the arrangements shown in FIGS. 3-6. The sensors 51 provide hair temperature information across substantially all of the area bounded by the shielding 46, thus providing a more accurate depiction of the temperature of hair in the hair treatment zone. There are no electrodes on the arm 30. The other arm 31 comprises two electrodes 40 arranged to interleave one another. There are no sensors disposed on the other arm 31. This may provide a simple means of manufacture and assembly.

In some examples (not shown), the sensor assembly 50 comprises sensors positioned outwardly of the electrodes 40, relative to the plane of the electrodes 40, but within the area bounded by the shielding 46.

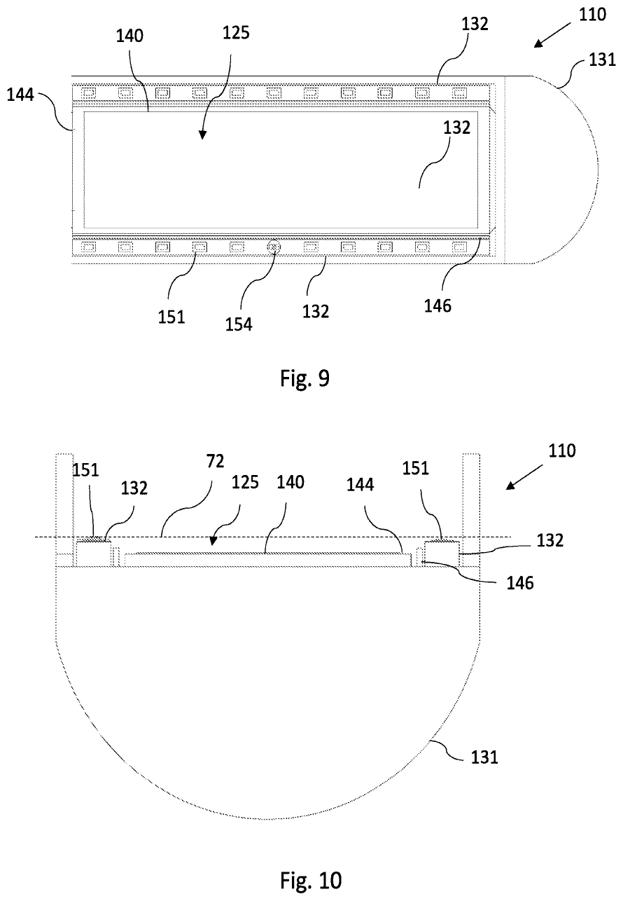

FIGS. 8 to 16 show various arrangements of an arm 130 of a further hair styling appliance 110. The hair styling appliance 110 is substantially similar to the hair styling appliance 10 described with reference to any of FIGS. 1 to 7 and corresponding components have the same reference numbers, but increased by 100.

The arm 130 of the each of the arrangements comprises an electrode 140 and a plurality of sensors 151. The electrode 140 comprises a single metal plate, but could take any other suitable configurations. For example, rather than a single electrode, the arm 130 may comprise a plurality of interleaving electrodes, such as that as shown in FIGS. 5-7.

In contrast to the sensor assembly 50 of the hair styling appliance 10, the sensors 151 of the sensor assembly 150 are located outside the shielding 146. Accordingly, the sensor assembly 150 senses a property of hair located outside the hair treatment zone 125.

Since electromagnetic fields generated by the electrodes are confined by the shielding 146 to the area bounded by the shielding 146 (i.e., confined to the hair treatment zone 125), the electromagnetic fields do not interfere, or interfere to a lesser extent, with the sensors 151. Accordingly, energisation of electrodes 140 and sensing by the sensor assembly 150 can occur concurrently and thus without impacting heating of hair. With this arrangement, a property of hair within the hair treatment zone 125 cannot be directly measured. However, this may be mitigated by providing sensors 151 on both sides of hair treatment zone 125 such that the property of the hair can be measured before and after the hair passes through the hair treatment zone 125. These measurements can then be used to infer the value of the property of hair within the hair treatment zone 125.

The sensor assembly 150 in this example is configured to sense a temperature of hair, but in other examples may be configured to additionally, or alternatively, sense another property, such as humidity or speed of movement, of the hair.

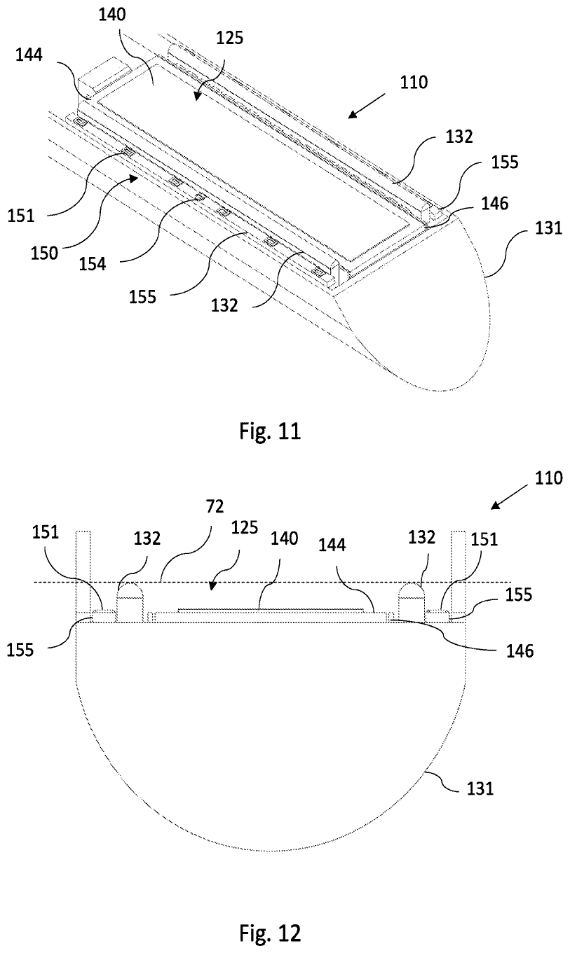

In the example shown in FIGS. 8-10 and the example shown in FIGS. 11 and 12, the sensor assembly 150 comprises a speed sensor 154 on each arm 130. The speed sensor 154 is configured to sense the speed of movement of hair through the hair treatment zone 125. In the present example, the speed sensor comprises an optical flow sensor. In other examples, the speed sensor may comprise alternative means for measuring the speed of the movement of the hair through the hair treatment zone 125. The sensor assembly 150 may comprise a pair of optical flow sensors, each of which is located on one of the arms. In some examples, an arm may comprise more than one speed sensor 154, for example on opposing sides of the shielding 146.

When the sensed speed of movement is below a speed threshold, the control system is operable to apply the alternating voltage to the electrodes 140 at a lower amplitude than when the sensed speed of movement is at or above the speed threshold. This may help to prevent over-heating and/or over-drying of hair. In some examples, the control system is operable to increase the amplitude of the alternating voltage if the sensed speed exceeds an upper threshold. This may help to ensure the hair is sufficiently heated during the shorter time it spends in the hair treatment zone 125 compared to when the sensed speed is below the upper threshold. In some examples, the control system is operable to issue an alert to a user based on the sensed speed of movement, to encourage the user to increase or decrease the speed of movement as required, for example to provide better styling performance.

In the example shown in FIGS. 8 to 10, the arm 130 comprises corralling strips 132 adjacent and parallel to opposing sides of the shielding 146. The sensors 151, 154 are embedded in the corralling strips 132 such that the sensors 151, 154 contact hair gripped between the corralling strips 132 on opposing arms of the hair styling appliance 110. Accordingly, the sensors 151, 154 contact hair outside the hair treatment zone 125. In this example, the sensors 151 are thermistors. In other examples, different types of contact temperature sensors might also be suitable, for example thermocouples.

In the example shown in FIGS. 11 and 12, the arm comprises corralling strips 132 adjacent and parallel to opposing sides of the shielding 146. The sensors 151, 154 are disposed on respective sensor carriages 155 parallel to and outward from the corralling strips 132 relative to the shielding 146. This may help to further reduce interference at the sensors 151, 154 by the electromagnetic fields generated by the electrodes 140.

The sensor carriages 155 have a shorter height than the corralling strips 132 such that the sensors 151, 154 in this example sense the temperature of hair outside the hair treatment zone 125 without contacting the hair. In this example, the sensors 151 are infrared sensors. In other examples, the corralling strips 132 may be omitted and the sensors 151, 154 may contact the hair to sense the temperature of the hair.

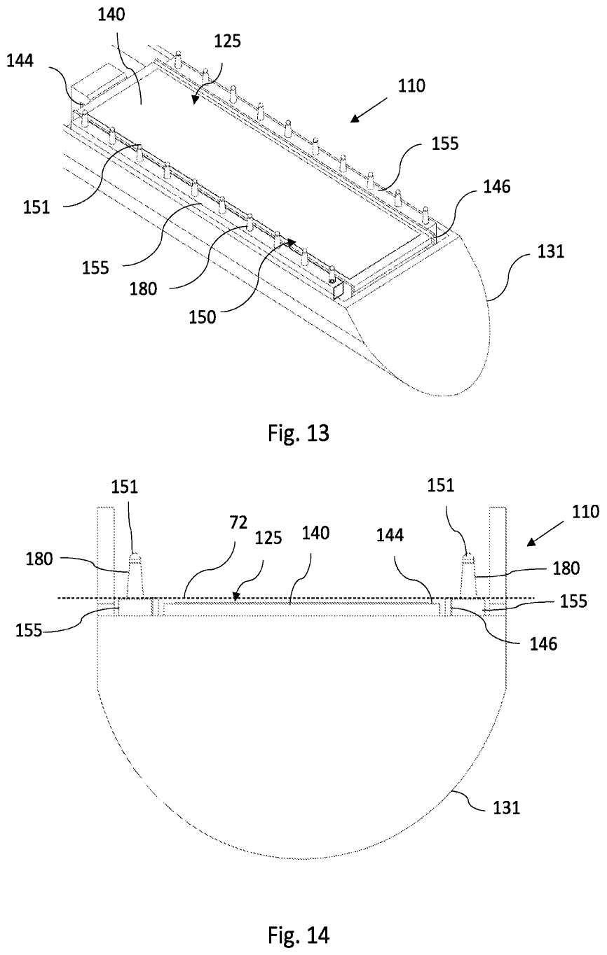

In the example shown in FIGS. 13 and 14, the hair styling appliance 110 comprises a plurality of bristles 180 upstanding from a sensor carriage 155 and distributed on opposing sides of the shielding 146. The bristles 180 are configured to detangle hair as the appliance 110 is pulled along the hair. The sensor assembly 150 comprises a plurality of sensors 151 each disposed on a respective bristle 180. By providing the sensors 151 on the bristles 180, the sensors 151 are more likely to contact the hair as the appliance is pulled along the hair. Accordingly, the sensors 151 can be sensors that contact hair to sense the temperature of the hair. Contact sensors may be substantially cheaper than other suitable sensors, for example infrared sensors. In this example, the sensors 151 are thermistors.

In this example, the bristles 180 are provided on only one arm 130 of the appliance 110. In other examples, bristles 180 may be provided on both arms 130.

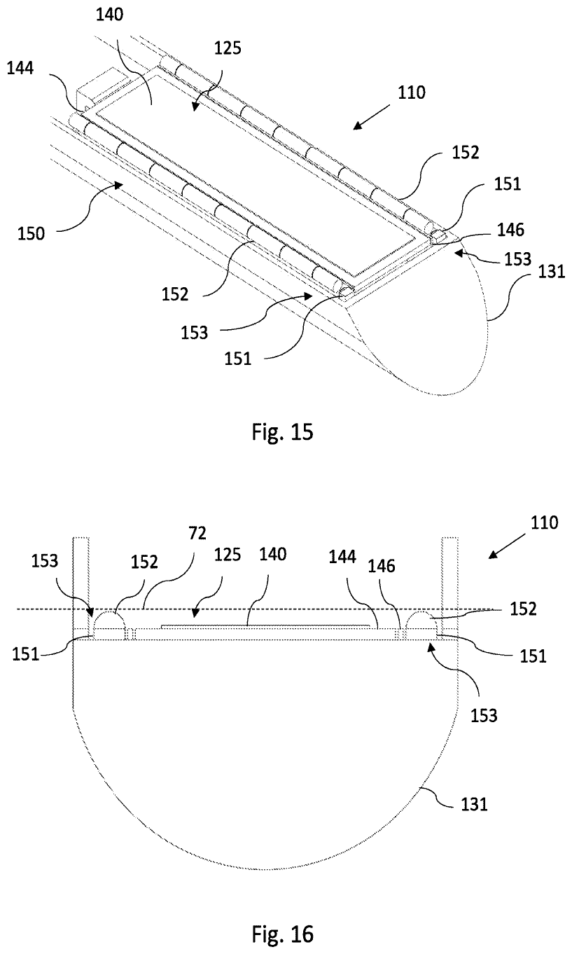

In the example shown in FIGS. 15 and 16, the hair styling appliance 110 comprises light pipes 152 adjacent and parallel to opposing sides of the shielding 146. At an end of each light pipe 152 is an array 153 of sensors 151 configured to receive light via the respective light pipe 152. Each array 53 comprises an infrared sensor to determine a temperature of hair passing over the respective light pipe 152 and an optical flow sensor to determine a speed of movement of hair passing over the respective light pipe 152. By providing the light pipes 52, the temperature of hair may be sensed along the full length of the hair treatment zone 125, which may provide greater accuracy compared to other arrangements.

This is achievable by providing only two sensors 151, compared to the plurality of sensors shown in the arrangements of FIGS. 8-14. Further, the sensors 151 can be positioned further away from the hair treatment zone 125 that in other arrangements, which may further reduce interference by the electrodes 40.

With each of the appliances 10, 110 described above, the sensor assembly 50, 150 or the control system may comprise a low pass filter to filter noise in the signals output of the sensors 51, 151, 154. The control system is configured to control energisation of the electrodes based on the determined property of the hair. Consequently, the appliance may therefore provide better styling results since energisation of the electrodes 40, 140 can be controlled based on the property of the hair (e.g., temperature, humidity, speed of travel). In particular, energisation may be controlled so as to avoid over-heating and/or over-drying of the hair.

The above embodiments are to be understood as illustrative examples of the invention. Further embodiments of the invention are envisaged. For example, the sensor assembly may comprise sensors located both inside and outside the shielding. Whilst the hair styling appliance described above and illustrated in the Figures resembles a hair straightener or flat iron, the features described above may be used with other types of hair styling appliance, such as a hairbrush or curling iron. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A hair styling appliance comprising:
electrodes;
a control system operable to energise the electrodes to heat hair dielectrically;
shielding bounding the electrodes to block an electromagnetic field generated by the electrodes when energised; and
a sensor assembly located outside the shielding, the sensor assembly to sense a property of hair.

2. The hair styling appliance as claimed in claim 1, wherein the electrodes are configured to heat dielectrically hair located within a hair treatment zone, the shielding confines the electromagnetic field generated by the electrodes to the hair treatment zone, and the sensor assembly senses a property of hair located outside the hair treatment zone.

3. The hair styling appliance as claimed in claim 1, wherein the control system is operable to:
energise the electrodes by applying an alternating voltage to the electrodes; and
vary a property of the alternating voltage in response to the sensed property of the hair.

4. The hair styling appliance as claimed in claim 3, wherein the control system is operable to apply a first alternating voltage to the electrodes if the sensed property meets a criterion, and apply second, different alternating voltage to the electrodes if the sensed property does not meet the criterion.

5. The hair styling appliance as claimed in claim 4, wherein the sensed property is temperature, humidity, or speed of movement of the hair; the criterion is met in the event that the temperature is less than a temperature threshold, the humidity is greater than a humidity threshold, or the speed of movement is greater than a speed threshold; and the second alternating voltage has a lower amplitude or a lower frequency than the first alternating voltage.

6. The hair styling appliance as claimed in claim 4, the sensor assembly configured to sense one of more of a temperature, a humidity, and a speed of movement of the hair.

7. The hair styling appliance as claimed in claim 1, wherein the sensor assembly comprises a plurality of sensors positioned adjacent to and distributed along an edge of the shielding.

8. The hair styling appliance as claimed in claim 7, wherein the plurality of sensors are additionally positioned adjacent to and distributed along an opposing edge of the shielding.

9. The hair styling appliance as claimed in claim 8, wherein the plurality of sensors are comprised in a hair-corralling strip extending parallel to the edge of the shielding, wherein a height of the hair-corralling strip is greater than a height of the shielding.

10. The hair styling appliance as claimed in claim 1, wherein the sensor assembly comprises a light sensor and a light pipe, the light pipe extending parallel to a edge of the shielding and configured to direct light to a light sensor of the sensor assembly.

11. The hair styling appliance as claimed in claim 1, wherein the sensor assembly comprises a sensor to contact hair to sense the property of the hair.

12. The hair styling appliance as claimed in claim 11, wherein the electrodes are configured to heat dielectrically hair located within a hair treatment zone, the shielding confines the electromagnetic field generated by the electrodes to the hair treatment zone, and the sensor assembly senses a property of hair located outside the hair treatment zone; and wherein the sensor contacts hair outside the hair treatment zone.

13. The hair styling appliance as claimed in claim 1, wherein the sensor assembly comprises a sensor to sense the property of hair without contacting the hair.

14. The hair styling appliance as claimed in claim 1, comprising a plurality of bristles, wherein the sensor assembly comprises a plurality of sensors, each sensor disposed on a respective bristle.

15. The hair styling appliance as claimed in claim 1, comprising a pair of arms movable between an open position and a closed position, each of the arms comprising at least one of the electrodes, and the shielding comprising a first shield disposed on a first arm of the pair of arms and a second shield disposed on a second arm of the pair or arms.

16. The hair styling appliance as claimed in claim 15, wherein:
when the arms are in the closed position, the control system is configured to energise the electrodes to heat dielectrically hair within a hair treatment zone located between the pair of arms;
the shielding confines the electromagnetic field generated by the electrodes to the hair treatment zone; and
the sensor assembly senses a property of hair located outside the hair treatment zone.

17. The hair styling appliance as claimed in claim 15, wherein the sensor assembly comprises a first sensor positioned on the first arm and a second sensor positioned on the second arm.
